(19) United States
(12) Patent Application Publication
(10) Pub. No.: US 2021/0081548 A1
(43) Pub. Date: Mar. 18, 2021

(54) Fractal File Encryption Engine and Method Thereof

(71) Applicant: Doqubiz Technology Co., Ltd., Taipei City (TW)

(72) Inventor: Xin Wang, Taipei City (TW)

(21) Appl. No.: 17/008,786

(22) Filed: Sep. 1, 2020

(30) Foreign Application Priority Data
Sep. 12, 2019 (TW) 108133071

(51) Int. Cl. G06F 21/60; G06F 21/62; H04L 9/08; H04L 9/06; G06F 16/13; G06F 16/182; G06F 3/06

(52) U.S. Cl. CPC G06F 21/602; G06F 21/6227; H04L 9/0877; H04L 9/0643; G06F 16/137; G06F 2221/2107; G06F 16/183; G06F 3/0623; G06F 3/0655; G06F 3/067; H04L 2209/38; G06F 16/134

(57) ABSTRACT

A fractal file encryption engine and a method thereof are provides. The fractal file encryption engine includes a file fractal module, an encryption server, a security chain module and a distributed queue database. The file fractal module divides a confidential file to generate a plurality of file fragments and a file index thereof. The encryption server encrypts each of the file fragment and the file index to generate a plurality of encrypted file fragments and an encrypted file index. The security chain module encrypts each of the encrypted file fragment and the encrypted file index to generate a plurality of encrypted file fragment chains and an encrypted file index chain. The distributed queue database stores the plurality of encrypted file fragment chains and the encrypted file index chain.

### FIELD OF THE INVENTION

The present invention relates to a file processing system and method thereof, in particular, a fractal file encryption engine and technology thereof.

### BACKGROUND OF THE INVENTION

Since the introduction of computers, digital documents have been stored in file formats, such as PDF, DOC, XLS, PPT and other file formats. With the popular use of computers, most documents are produced with word processing systems to perform documents' Processing and documents' storage.

However, in view of the popular coverage of computers and network systems, issues of information security have become a potential concern. Electronic files stored in computers have exposed security issues related to file formats. Recently, there are many information security systems which are focused on encrypting and protecting for storing files. Shortly, it compresses and assigns passwords to files in various file formats, and then develops a system for reading or unlocking files as a mode of file decryption.

However, the multiple file encryption system on the market all have the same issues, especially, the multiple issues are derived from the storage of file format, as below:

1. File storage will be wide open for anyone's usage if the equipment is hacked.

2. File storage has issues of missing, changed (modified or covered up).

3. Existing file encryption methods are often cracked.

4. If the file is downloaded or taken away, it will be impossible to issue a new version or recycle it later.

5. Usually, many file formats have to be printed on paper (because of national conditions or conditions need to be printed), it has been a problem that how to control confidentiality.

### SUMMARY OF THE INVENTION

In view of the above conventional issues, the object of the present invention is to provide a fractal file encryption engine and technology thereof, which is used to solve the issues encountered by the conventional art.

Based on the above object, the present invention provides a fractal file encryption engine, which includes a file fractal module, an encryption server, a security chain module and a distributed queue database. The file fractal module divides a confidential file to generate a plurality of file fragments and a file index thereof. The encryption server connects with the file fractal module and receives the plurality of file fragments and the file index thereof, then encrypting each of the plurality of file fragments and the file index thereof to generate a plurality of encrypted file fragments and an encrypted file index. The security chain module connects with the encryption server and receiving the plurality of encrypted file fragments and an encrypted file index, then encrypting the plurality of encrypted file fragments and the encrypted file index to generate a plurality of encrypted file fragment chain and an encrypted file index chain. The distributed queue database connects with the security chain module and stores the plurality of encrypted file fragment chains and the encrypted file index chain

Preferably, the confidential file is converted to a fractal default format when fracturing. However, the original confidential documents in the manuscript format will be archived and hidden by the fractal encryption engine, and used for recovering the confidential documents in the future.

Preferably, the fractal file encryption engine further comprises a distributed non-filed file fragment queue storage system, which determines node model and combining order of the file index corresponding to the plurality of file fragments.

Preferably, the encryption server encrypted each of the file fragments and the file index with a first encryption key of a random mode of asymmetric calculation derived form a hardware security module.

Preferably, after each of the encrypted file fragments enters the security chain module to form the plurality of file fragment chains and the encrypted file index enters the security chain module to form the file index chain; with a hash of the security chain module which is generated with a second encryption key of a random mode of asymmetric calculation, the security chain module encrypts each of the plurality of file fractal chain to generate the plurality of the encrypted file fractal chains and encrypts the file index chain to generate the encrypted file index chain.

Based on the above object, the present invention further provides a fractal file encrypting method, which comprises below steps: A confidential file is divided to generate a plurality of file fragments and a file index thereof with a file fractal module; the plurality of file fragments and the file index thereof are encrypted to generate a plurality of encrypted file fragments and an encrypted file index with an encryption server; the plurality of encrypted file fragments and the encrypted file index encrypted to generate a plurality of encrypted file fragment chains and an encrypted file index chain with a security chain module; the plurality of encrypted file fragment chains and the encrypted file index chain are stored with a distributed queue database.

Preferably, the confidential file is converted to a fractal default format when fracturing. However, the original confidential documents in the manuscript format will be archived and hidden by the fractal encryption engine, and used for recovering the confidential documents in the future.

Preferably, the fractal file encryption engine further comprises a distributed non-filed file fragment queue storage system, which determines node model and combining order of the file index corresponding to the plurality of file fragments.

Preferably, the encryption server encrypted each of the file fragments and the file index with a first encryption key of a random mode of asymmetric calculation derived form a hardware security module.

Preferably, after each of the encrypted file fragments enters the security chain module to form the plurality of file fragment chains and the encrypted file index enters the security chain module to form the file index chain; with a hash of the security chain module which is generated with a second encryption key of a random mode of asymmetric calculation, the security chain module encrypts each of the plurality of file fractal chain to generate the plurality of the encrypted file fractal chains and encrypts the file index chain to generate the encrypted file index chain.

As mentioned above, the fractal file encryption engine and technology thereof of the present invention can divide a confidential file into the plurality of file fragments and the file index thereof with the file fractal module, then encrypting and storing in the distributed queue database with applying the block chain technology, to achieve the effect of encryption layer by layer.

### DESCRIPTION OF THE DIAGRAMS

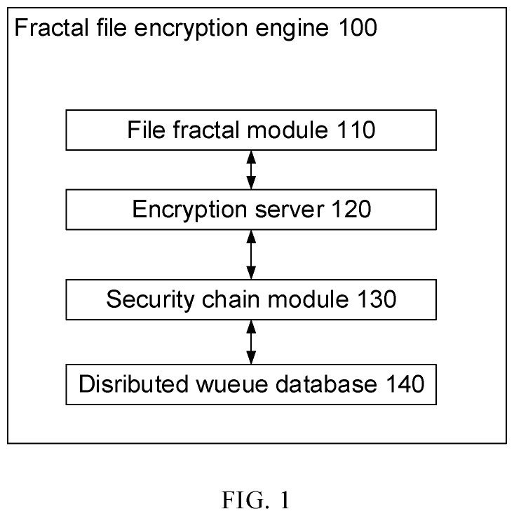

FIG. 1 is a first block diagram of the fractal file encryption engine according to the present invention;

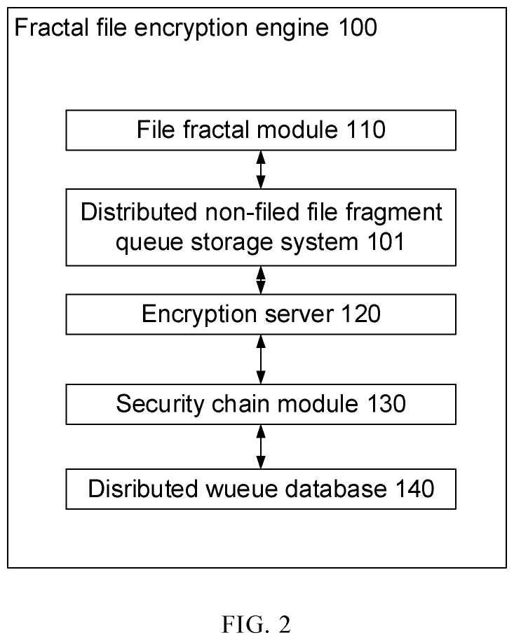

FIG. 2 is a second block diagram of the fractal file encryption engine according to the present invention;

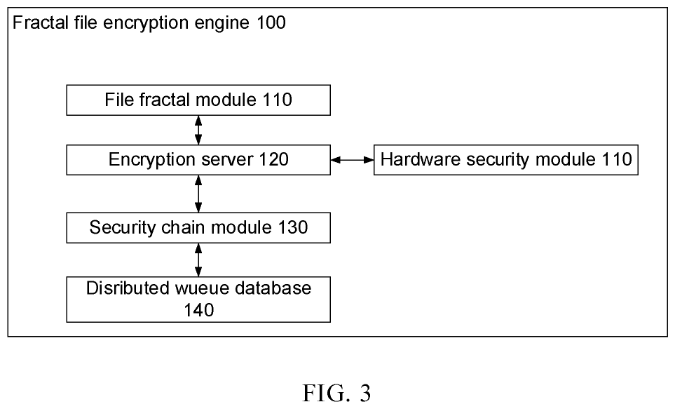

FIG. 3 is a third block diagram of the fractal file encryption engine according to the present invention; and

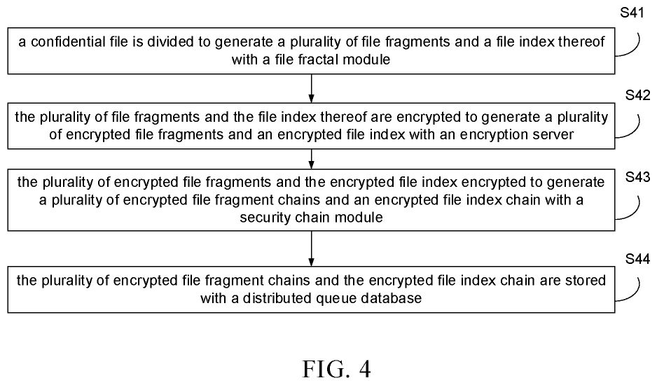

FIG. 4 is a flow chart of the fractal file encrypting method according to the present invention.

### DETAILED DESCRIPTION OF THE PREFERRED EMBODIMENTS

In order to facilitate the understanding of the features, content and advantages of the present invention and the effects that can be achieved, the present invention is combined with the drawings and described in detail in the form of an embodiment as follows, and the drawings used therein are The subject matter is only for the purpose of illustration and auxiliary description, and may not be the true scale and precise configuration after the implementation of the present invention. Therefore, the scale and configuration relationship of the attached drawings should not be interpreted to limit the scope of rights of the present invention in actual implementation.

Please refer to FIG. 1, which is a first block diagram of the fractal file encryption engine according to the present invention. A fractal file encryption engine 100 of the present invention, which includes a file fractal module 110, an encryption server 120, a security chain module 130 and a distributed queue database 140.

Continued, the file fractal module 110 is used to divide a confidential file to generate a plurality of file fragments and a file index thereof. The file fragment (or part) is not belong to any file format and is stored in a storage space with queue method. Besides, the file index (or index) records the combination method of the plurality of file fragments.

The encryption server 120 connects with the file fractal module 110 and receives the plurality of file fragments and the file index thereof, then encrypts each of the plurality of file fragments and the file index thereof to generate a plurality of encrypted file fragments and an encrypted file index. The encryption server 120 determines the node model corresponding to the plurality of file fragments before encrypting the file index to disrupt the order of combination thereof.

The security chain module 130 connects with the encryption server 120 and receives the plurality of encrypted file fragments and an encrypted file index, then encrypting the plurality of encrypted file fragments and the encrypted file index to generate a plurality of encrypted file fragment chain and an encrypted file index chain by a method of fractal node. The encrypted file index chain comprises the combining method of the plurality of encrypted file fragment chain, and further comprises a node model corresponding to the plurality of encrypted file and messes up the combining method.

The distributed queue database 140 connects with the security chain module 130 and stores the plurality of encrypted file fragment chains and the encrypted file index chain

Continued, the confidential file is converted to a fractal default format when fracturing. The fractal default format can be file format with extension such as .tif or .pdf, which is convenient to be viewed by authorized person while fractal recovery. At the same time, the original confidential documents in the manuscript format will be archived and hidden by the fractal encryption engine, and used for the legal validity of recovering the confidential documents in the future.

Further, as shown in FIG. 2, the fractal file encryption engine 100 further comprises a distributed non-filed file fragment queue storage system 101. The distributed non-filed file fragment queue storage system 101 determines node model and combining order of the file index corresponding to the plurality of file fragments.

However, as shown in FIG. 3, the encryption server 120 encrypted each of the file fragments and the file index with a first encryption key of a random mode of asymmetric calculation derived form a hardware security module 102 (HSM).

On the other side, in the step that after each of the encrypted file fragments enters the security chain module 130 to form the plurality of file fragment chains and the encrypted file index enters the security chain module 130 to form the file index chain; with a hash of the security chain module 130 which is generated with a second encryption key of a random mode of asymmetric calculation, the security chain module encrypts each of the plurality of file fractal chain to generate the plurality of the encrypted file fractal chains and encrypts the file index chain to generate the encrypted file index chain.

Although the foregoing description of the fractal file encryption engine of the present invention has also explained the concept of the fractal file encrypting method of the present invention, for the sake of clarity, a detailed flowchart is shown below.

Please refer to FIG. 4, which is a flow chart of the fractal file encrypting method according to the present invention. As shown in FIG. 4, the fractal file encrypting method, this is suitable to be used in the fractal file encryption engine. The FIG. 4 is a flow chart of the fractal file encrypting method according to the present invention comprises below steps:

In step S41, a confidential file is divided to generate a plurality of file fragments and a file index thereof with a file fractal module.

In step S42, the plurality of file fragments and the file index thereof are encrypted to generate a plurality of encrypted file fragments and an encrypted file index with an encryption server.

In step S43, the plurality of encrypted file fragments and the encrypted file index encrypted to generate a plurality of encrypted file fragment chains and an encrypted file index chain with a security chain module.

In step S44, the plurality of encrypted file fragment chains and the encrypted file index chain are stored with a distributed queue database.

Continued, in the step that the confidential file is converted to a fractal default format when fracturing. The fractal default format can be file format with extension such as .tif or .pdf, which is convenient to be viewed by authorized person while fractal recovery. At the same time, the original confidential documents in the manuscript format will be archived and hidden by the fractal encryption engine, and used for the legal validity of recovering the confidential documents in the future.

Further, the fractal file encrypting method further comprises: The distributed non-filed file fragment queue storage system 101 determines node model and combining order of the file index corresponding to the plurality of file fragments.

The encryption server 120 encrypted each of the file fragments and the file index with a first encryption key of a random mode of asymmetric calculation derived form a hardware security module (HSM).

On the other side, after each of the encrypted file fragments enters the security chain module 130 to form the plurality of file fragment chains and the encrypted file index enters the security chain module 130 to form the file index chain; with a hash of the security chain module 130 which is generated with a second encryption key of a random mode of asymmetric calculation, the security chain module encrypts each of the plurality of file fractal chain to generate the plurality of the encrypted file fractal chains and encrypts the file index chain to generate the encrypted file index chain. With the above encryption method, even if the key of the encryption server 120 is stolen, the encrypted file that has been linked cannot be decrypted alone.

The detailed description and embodiments of the fractal file encryption method of the present invention had been described while describing the fractal file encryption engine, so it will not be repeated here for the sake of brief description.

As mentioned above, the fractal file encryption engine and technology thereof of the present invention can divide a confidential file into the plurality of file fragments and the file index thereof with the file fractal module, then encrypting and storing in the distributed queue database with applying the block chain technology, to achieve the effect of encryption layer by layer.

The above-mentioned embodiments are only to illustrate the technical ideas and features of the present invention, and their object is to enable those skilled in the art to understand the content of the present invention and implement them accordingly. The scope of patents, that is, all equal changes or modifications made in accordance with the spirit of the present invention should still be covered by the scope of patents of the present invention.

What is claimed is:

1. A fractal file encryption engine, comprising:
a file fractal module, dividing a confidential file to generate a plurality of file fragments and a file index thereof;
an encryption server, connecting with the file fractal module and receiving the plurality of file fragments and the file index thereof, then encrypting each of the plurality of file fragments and the file index thereof to generate a plurality of encrypted file fragments and an encrypted file index;
a security chain module, connecting with the encryption server and receiving the plurality of encrypted file fragments and an encrypted file index, then encrypting the plurality of encrypted file fragments and the encrypted file index to generate a plurality of encrypted file fragment chain and an encrypted file index chain; and
a distributed queue database, connecting with the security chain module and storing the plurality of encrypted file fragment chains and the encrypted file index chain.

2. The fractal file encryption engine according to claim 1, wherein the confidential file is converted to a fractal default format when fracturing.

3. The fractal file encryption engine according to claim 1, further comprising a distributed non-filed file fragment queue storage system, which determines node model and combining order of the file index corresponding to the plurality of file fragments.

4. The fractal file encryption engine according to claim 1, wherein the encryption server encrypted each of the file fragments and the file index with a first encryption key of a random mode of asymmetric calculation derived form a hardware security module.

5. The fractal file encryption engine according to claim 1, after each of the encrypted file fragments enters the security chain module to form the plurality of file fragment chains and the encrypted file index enters the security chain module to form the file index chain; with a hash of the security chain module which is generated with a second encryption key of a random mode of asymmetric calculation, the security chain module encrypts each of the plurality of file fractal chain to generate the plurality of the encrypted file fractal chains and encrypts the file index chain to generate the encrypted file index chain.

6. A fractal file encrypting method, comprising:
dividing a confidential file with a file fractal module to generate a plurality of file fragments and a file index thereof;
encrypting the plurality of file fragments and the file index thereof with an encryption server to generate a plurality of encrypted file fragments and an encrypted file index;
encrypting the plurality of encrypted file fragments and the encrypted file index with a security chain module to generate a plurality of encrypted file fragment chains and an encrypted file index chain; and
storing the plurality of encrypted file fragment chains and the encrypted file index chain with a distributed queue database.

7. The fractal file encrypting method according to claim 6, wherein the confidential file is converted to a fractal default format when fracturing.

8. The fractal file encrypting method according to claim 6, further comprising a distributed non-filed file fragment queue storage system, which determines node model and combining order of the file index corresponding to the plurality of file fragments.

9. The fractal file encrypting method according to claim 6, wherein the encryption server encrypted each of the file fragments and the file index with a first encryption key of a random mode of asymmetric calculation derived form a hardware security module.

10. The fractal file encrypting method according to claim 6, after each of the encrypted file fragments enters the security chain module to form the plurality of file fragment chains and the encrypted file index enters the security chain module to form the file index chain; with a hash of the security chain module which is generated with a second encryption key of a random mode of asymmetric calculation, the security chain module encrypts each of the plurality of file fractal chain to generate the plurality of the encrypted file fractal chains and encrypts the file index chain to generate the encrypted file index chain.
